(19) United States
(12) Patent Application Publication
(10) Pub. No.: US 2004/0079212 A1
(43) Pub. Date: Apr. 29, 2004

(54) Mandreled tube punching device

(75) Inventors: Leonard A. Deni, East Amherst, NY (US); Joseph A. Deni, East Amherst, NY (US); Frank Deni, Williamsville, NY (US)

Correspondence Address: SIMPSON & SIMPSON, PLLC, 5555 MAIN STREET, WILLIAMSVILLE, NY, 14221-5406, US

(73) Assignee: Unittool Punch & Die Company, Inc., Buffalo, NY

(21) Appl. No.: 10/280,575

(22) Filed: Oct. 25, 2002

(51) Int. Cl. B23D 21/14

(52) U.S. Cl. 83/178; 83/257

(57) ABSTRACT

A mandreled tube punch includes a cantilevered mandrel and an arbor housing for securing the cantilevered mandrel. The cantilevered mandrel has a bore longitudinally disposed therethrough and the mandrel is adapted to secure a workpiece, or tubular stock, to be punched. An evacuation apparatus in the form of a pushrod is disposed within the longitudinally disposed mandrel bore and is arranged for movement therein and removes punched material from the work area. The punching device further includes a punching means for punching the workpiece and includes a punch housing having an aperture that accepts the workpiece positioned on the mandrel. The punch assembly prevents the workpiece from becoming damaged as a result of punching operations and efficiently, effectively and safely removes punched material from the work area.

### FIELD OF THE INVENTION

The present invention broadly relates to a device for punching a workpiece, and more particularly, to a device for punching a workpiece comprising tubular stock without causing damage thereto as a result of punch press operations. The present invention also relates to a tube-punching device having means for efficiently, effectively and safely securing a workpiece and removing punched material from the work area.

### BACKGROUND OF THE INVENTION

Apparatus for performing punching operations are fairly well known, as are devices and methods for punching tubular stock. Hence, mandrels positioned within tubular stock for providing support to a workpiece being punched are also known. Additionally, means for removing punched material from the work area are also known, such means typically comprise mechanical means for removing punched material from the workpiece being punched or pneumatic means which carry away punched material via pressurized air. However, these known mandrel means do not effectively support the workpiece being punched and do not effectively remove punched material from the work area. Additionally, pneumatic means can comprise workplace hazards as fine particles of punched material may become airborne and inhaled.

For example, U.S. Pat. No. 3,698,247 (Coulon et al.) discloses a punching apparatus for tubular stock comprising a pair of oppositely disposed mandrel members and a wedge-shaped member operatively arranged for insertion between the mandrel members for purposes of varying the diameter of the mandrel to accord with the diameter of a tube to be punched. The oppositely disposed mandrel members disclosed by Coulon et al. each include a through-bore in relative communication with one another which accept the head of a punch and catch punched material. A problem associated with the Coulon et al. invention is that punched material produced during punching operations is not efficiently and effectively removed from the work area. Indeed, the punched material produced by the Coulon et al. invention tends to collect in the through-bores of the mandrel members. Thus, frequent work stoppages are required in order to remove the material. U.S. Pat. No. 3,489,045 (Ray) discloses a mandrel member for insertion into tubular stock that comprises a pair of tapered ends and a flat upper surface having a vertically disposed bore therethrough. However, the flat upper surface of the mandrel disclosed by Ray allows damage to occur to the tubular stock. Damage resulting from the use of the invention disclosed by Ray typically takes the form of dimples or flat spots on the rounded surface of the cylindrical tube; in applications where specific, or high, tolerances are essential, this type of damage is unacceptable. Additionally, Ray does not disclose an effective means for removing punched material from the work area. U.S. application Ser. No. 4,905,553 (Thornborrow et al.) discloses a mandrel operatively arranged for insertion into tubular stock for purposes of supporting punching operations and preventing punched material from inhibiting the work area. Despite these features, use of the invention disclosed by Thornborrow et al. can result in damage to the tubular stock due to the fact that the means for removing punched material is not capable of simultaneously supporting the walls of the tubular stock. U.S. Pat. No. 4,426,899 (Long et al.) discloses an apparatus for punching tubular stock comprising a punch arbor for supporting tubing to be punched. The punch arbor disclosed by Long et al., however, does not comprise means for removing punched material from the work area. Finally, U.S. Pat. No. 3,111,873 (Lind) discloses a hollow mandrel having an elongated channel. However, the elongated channel in the mandrel disclosed by Lind is operatively arranged for uniformly displacing perforations in tubing and does not effectively support the walls of the tube. In addition, the means for evacuating punch material comprises pneumatic means.

Hence, while the desirability of supporting tubular stock during punching operations is fairly well known, none of the devices currently known are operatively arranged to prevent damage to the tubular stock while simultaneously providing an efficient, effective and safe means for removing punched material deposited as a result of punching operations.

Accordingly, there is a long felt need for a punch assembly capable of punching tubular stock without causing damage to the tubular stock and which is operatively arranged for efficient, effective and safe removal of punched material from the work area.

### SUMMARY OF THE INVENTION

The present invention broadly comprises a punching device for a workpiece. The punching device includes a cantilevered mandrel and an arbor housing for securing the cantilevered mandrel. The cantilevered mandrel has a bore longitudinally disposed therethrough and the mandrel is adapted to secure a workpiece, or tubular stock, to be punched. Evacuation means comprising a pushrod is disposed within the longitudinally disposed mandrel bore and is arranged for translational movement therein for removing punched material from the work area. The punching device further comprises a punching means for punching the workpiece and includes a punch housing having an aperture for accepting the workpiece positioned on the mandrel. The punch assembly prevents the workpiece from becoming damaged as a result of punching operations and efficiently, effectively and safely removes punched material from the work area.

A general object of the present invention is to provide a means for punching through-bores in tubular stock without causing damage to tubular stock.

Another object of the present invention is to provide an efficient, effective and safe means for removing punched material from the work area.

A further object of the invention is to provide a means for efficiently and effectively punching through-bores in tubular stock that is easy to operate and which reduces manufacturing time and expense.

A final object is to combine the present invention with a means for indexing tubular stock to be punched.

These and other objects, features and advantages of the present invention will become readily apparent to those having ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of the apparatus of the present invention;

FIG. 2 is a side view of the right side of the apparatus of the present invention;

FIG. 3 is a view taken along line 3-3 of FIG. 1;

FIG. 4 is a view taken along line 4-4 of FIG. 1;

FIG. 5 is a side view of the pushrod and pushrod handle assembly of the present invention;

FIG. 6 is a top view of the pushrod and pushrod handle assembly of the present invention;

FIG. 7 is a top view of the apparatus of the present invention;

FIG. 8 is a side view of a punch assembly of the present invention;

FIG. 9 is a top view of a punch support plate of the present invention;

FIG. 10 is a view of the pushrod of the present invention;

FIG. 11 is a top view of the mandrel of the present invention;

FIG. 12 is a front elevation view of the apparatus of the present invention in the open, non-actuated, position;

FIG. 13 is a front elevation view of the present invention in the open, non-actuated, position further comprising a cutaway and expanded view of the punch housing;

FIG. 14 is a front elevation view of the present invention in the closed, actuated, position further comprising a cutaway and expanded view of the punch housing;

FIG. 15 is a front elevation view of the present invention comprising a cutaway and expanded view of the punch housing which shows the operation of the pushrod handle assembly for purposes of evacuating the work area;

FIG. 16 is a view showing typical damage to cylindrical tubular stock resulting from the use of punch assemblies known in the art;

FIG. 17 is a view of a non-damaged cylindrical tubular stock punched using the present invention;

FIG. 18 is a front elevation view of the apparatus of the present invention further comprising an indexing assembly for indexing tubular stock;

FIG. 19 is a side view of the indexing assembly of the present invention; and,

FIG. 20 is a view of the present invention configured for use with a punch press.

### DETAILED DESCRIPTION OF THE INVENTION

It should be appreciated at the outset that, in the detailed description that follows, like reference numbers on different drawing views are intended to identify identical structural elements of the invention in the respective views. Additionally, it should also be appreciated that the particular embodiment disclosed herein, infra, is presented solely for purposes of illustration; in no way is the scope of the present invention limited to the particular embodiment disclosed herein. Indeed, while a device for punching cylindrical tubular stock is disclosed herein, the present invention and its components may be configured and/or modified for punching a variety of non-cylindrical stock, for instance, the present invention could be configured for punching square, rectangular or triangular stock, etc. Furthermore, other equivalents and methods for assembling and configuring the device of the present invention are contemplated and encompassed by the instant disclosure. In the detailed description that follows, while a “punching device” and “punching” a workpiece are discussed and described herein in the context of perforating a workpiece, it should be appreciated by those having ordinary skill in the art that “punching device”, “punching” and like phrases are used interchangeably to connotate many types of operations performed upon a workpiece; for example, in addition to perforating a workpiece one may “punch” a workpiece or use a “punch” to emboss or to form an indentation therein.

Adverting now to the Figures, the mandreled punching device of the present invention broadly comprises means for forcing a punch means through the walls of a workpiece, tubular stock, to punch holes therein. The device of the present invention includes a cantilevered mandrel operatively arranged to accept the workpiece, or tube to be punched, and is adapted for close fit with the workpiece such that damage is prevented. The device also includes an aperture having a shape corresponding to the workpiece for purposes of supporting an end end, or intermediate portion, of the workpiece. The present invention is also configured for causing the return of one or more punch assemblies to a starting position upon completion of punching operations. The present invention also includes means for effecting the removal of punched material from the work area.

### Structure of the Invention

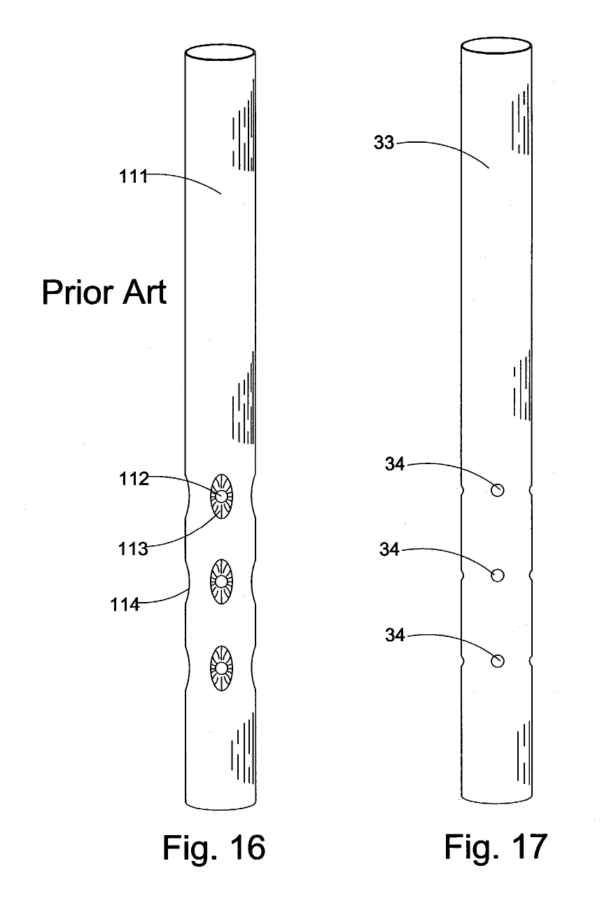

As shown in FIGS. 16 and 17, the mandreled tube punching device of the present invention is generally configured for punching holes 34 in tubular stock 33 such that damage to the workpiece, or tubular stock, is prevented. As shown more clearly in FIG. 16, tubular stock punched with punching devices known in the art 111 is usually damaged. The damage occurring to the tubular stock as a result of using punching devices known in the art typically manifests itself as dimples 113, distortion 114 of punched holes 112 or flattening of the cylindrical tube surface.

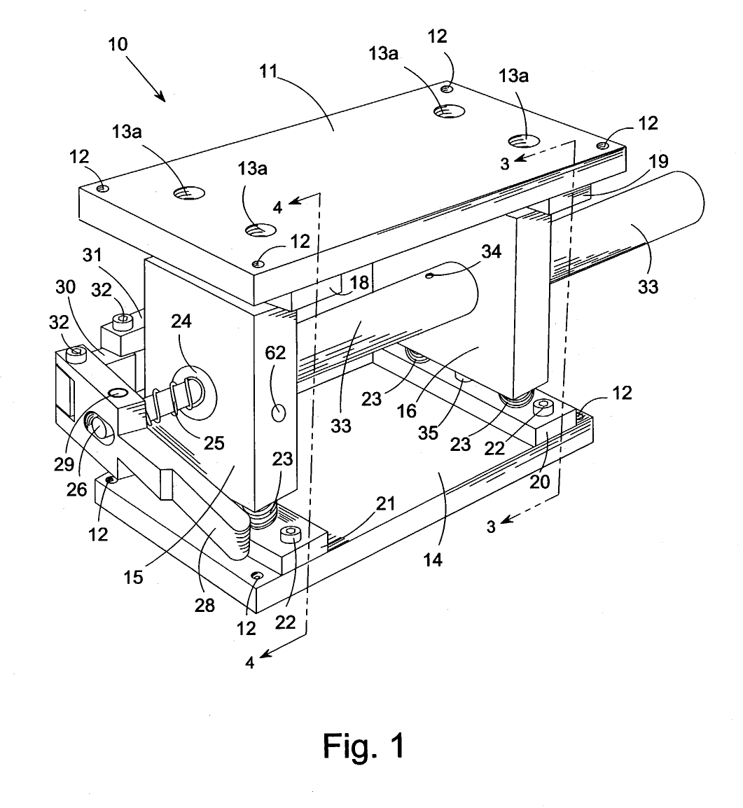

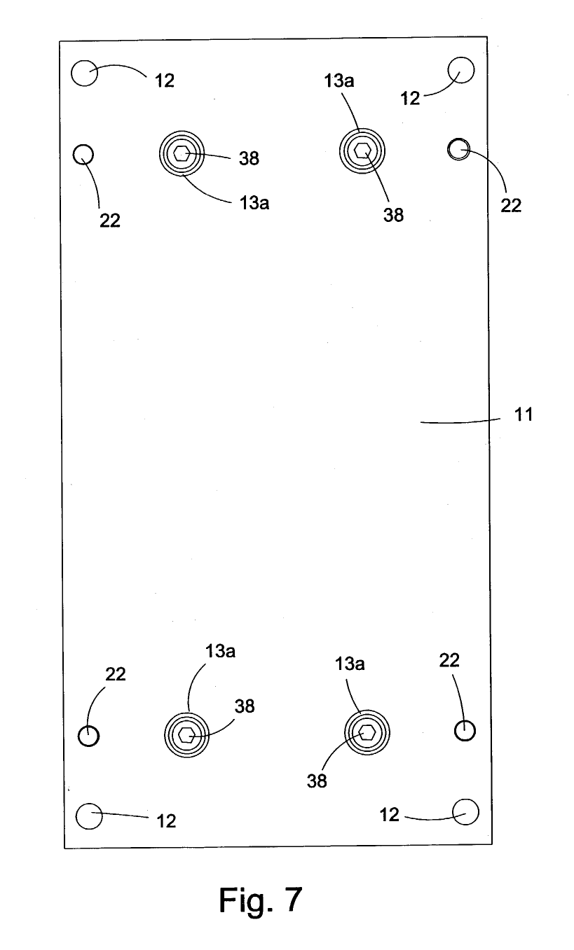

Referring now to FIGS. 1-11, mandreled tube punching device 10 of the present invention generally comprises upper punch plate 11, lower punch plate 14, arbor housing 15, punch housing 16, a pair of arbor support plates 18, 21, a pair of punch support plates 19, 20, pushrod 26, pushrod handle 28, mandrel 24 and at least one punch assembly 41, 35.

Referring specifically now to FIGS. 1-4 and 7, upper and lower punch plates 11 and 14 generally comprise a plurality of mounting through-bores 12, a plurality of arbor through-bores 13a and a plurality of threaded through-bores 17a. Mounting through-bores 12 are generally provided for mounting the invention to a conventional punch press or similar structure. Threaded through-bores 17a are operatively arranged for registration with support plate mounting through-bores 17b of upper and lower punch and arbor support plates 19, 20, 18 and 21, respectively (collectively referred to as “the support plates”), such that the support plates may be secured to the upper and lower punch plates by means of bolts 22. Upper and lower punch plates 11 and 14 also comprise a plurality of arbor through-bores 13a operatively arranged for registration with arbor counter through-bores 13b of the support plates. Arbor through bores 13a and arbor counter through-bores are, thus, arranged such that the heads of arbor support bolts 38 freely pass through arbor through-bores 13a yet engage arbor counter-through-bores 13b of the support plates. It should be appreciated that while a plurality of bolt means are described herein for purposes of securing various components of the present invention to one another, other appropriate means are also contemplated.

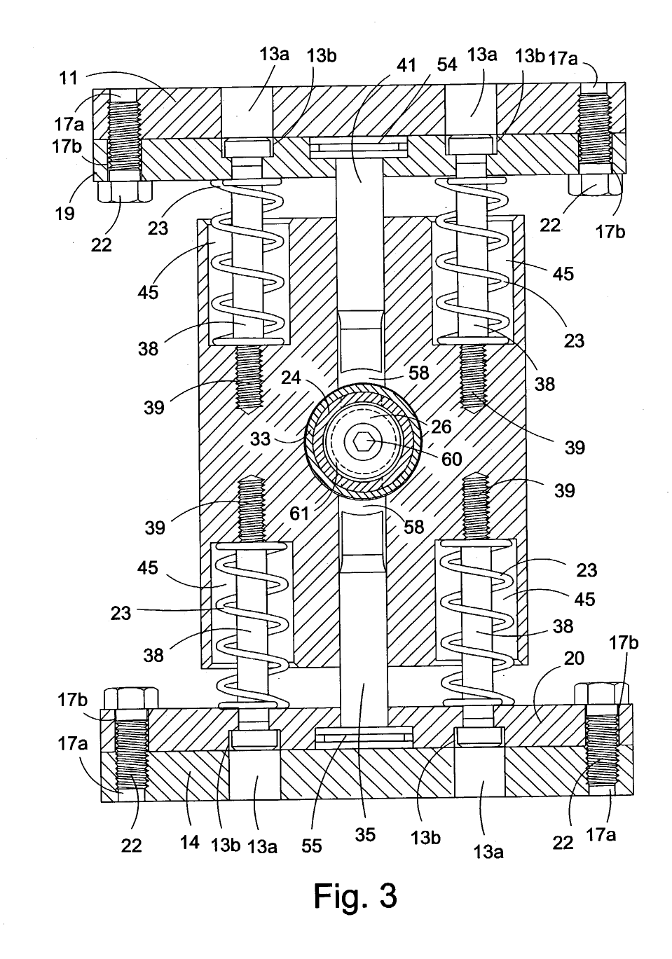

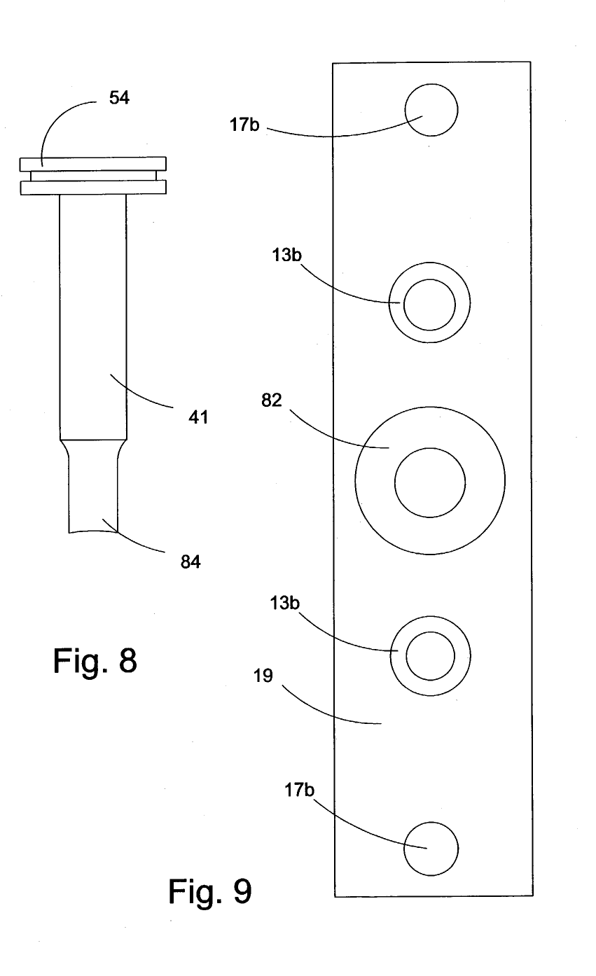

The support plates of the present invention are all generally similar in structure; as shown in FIG. 9, all generally comprise a pair of support plate mounting bores 17b and arbor counter through-bores 13b. However, it should be appreciated that upper and lower punch support plates 19 and 20, respectively, additionally comprise punch cap counter bores 82 for accepting punch support caps 54 and 55 of the upper and lower punch assemblies (shown in FIGS. 3 and 8). Hence, as shown more clearly in FIG. 3, the upper and lower punch support plates, in combination with upper and lower punch plates 11 and 14, are configured for securing upper and lower punch assemblies 41 and 35 therebetween.

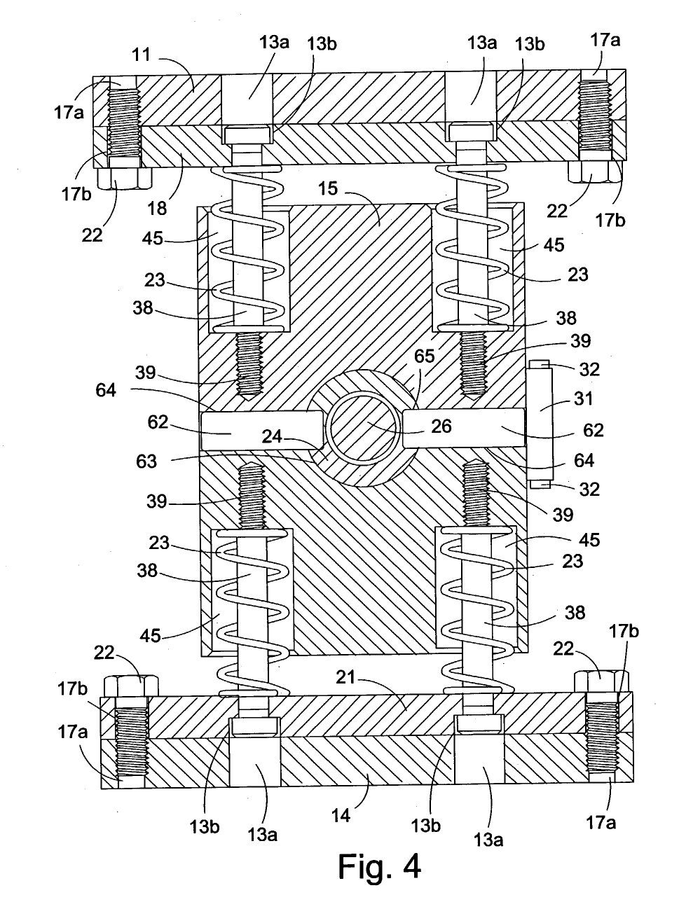

Arbor housing 15 and punch housing 16 are also generally similar in structure; each is provided with a plurality of housing counter-bores 45 for accepting compression springs 23 and threaded bolt portions 39 of arbor support bolts 38. As shown in FIGS. 3 and 4, the arbor support bolts 38 are operatively arranged to secure the support plates to arbor and punch housings 15 and 16, respectively, while simultaneously allowing the translational movement of the support and punch plates relative thereto. Compression springs 23 are operatively arranged about the arbor support bolts 38 such that one end of each spring engages an abutment wall of each housing counter-bore and the other end of each spring 23 engages the support plates. Hence, compression springs 23 are operatively arranged to assert an outwardly directed bias upon the support plates, which bias is ultimately asserted upon the lower and upper punch plates secured thereto. As indicated supra, since the heads of arbor support bolts 38 are operatively arranged to engage counter-bores 13b of the support plates, the outward translational movement of the support plates, resulting from the bias of the compression springs, is arrested upon engagement therewith.

Referring now to FIGS. 4 and 6, arbor housing is operatively arranged for releasably securing mandrel 24 and passing the punch material ejection means of the invention. Hence, arbor housing 15 comprises arbor housing aperture 63, whose axis is disposed in the planar surface of the arbor housing. The arbor housing aperture is operatively arranged to releasably secure mandrel 24 and comprises a pair of retaining pin bores 64, for accepting mandrel retaining pins 62. The bore axes of retaining pin bores 64 are generally perpendicularly disposed with respect to arbor housing aperture 63 and are arranged for intersection therewith. Hence, retaining pin bores 64 are configured for accepting retaining pins 62, which engage mandrel retaining pin bores 65 of mandrel 24 to secure the mandrel in the arbor housing aperture. It should be appreciated, however, that retaining pin bores 64 and mandrel retaining pin bores 65 could be positioned other than perpendicularly with respect to the arbor housing aperture. Arbor housing additionally comprises pushrod mounting bracket 31 for securing the pushrod assembly of the present invention.

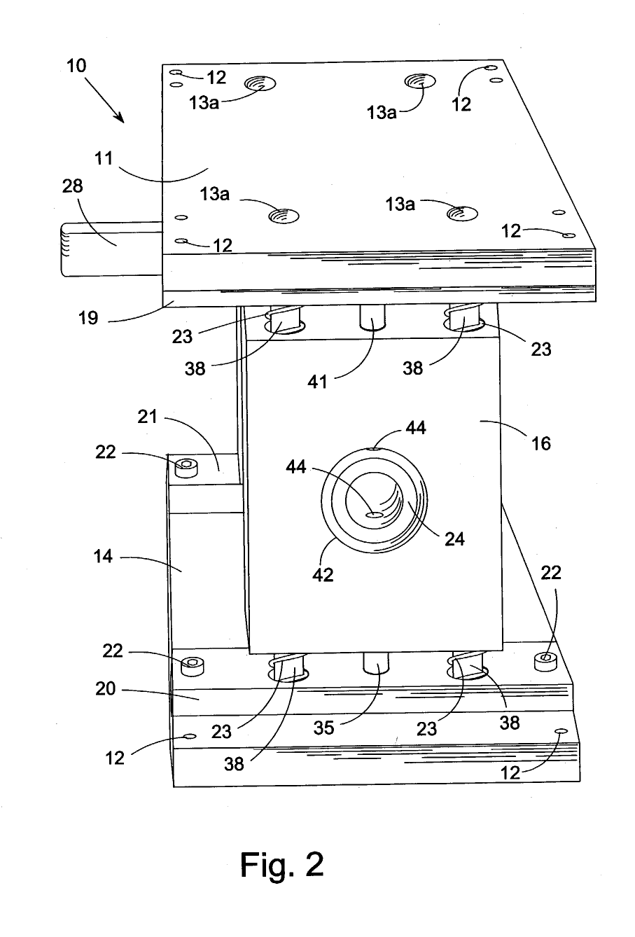

Referring now to FIGS. 2-3 and 13-15, the punch housing 16 is operatively arranged for passing a workpiece therethrough, supporting a workpiece and punching. Hence, punch housing 16 comprises punch housing aperture 42, which, as shown in FIGS. 2 and 3 is centrally disposed in the planar surface of the punch housing and is operatively arranged for accepting workpiece 33 therethrough. Punch housing 16 also comprises a pair of punch through-bores 58 disposed such that their bore axes are arranged for communication with punch housing aperture 42. While the punch through-bores are shown as being parallel to the direction of the punching force applied during punching operations, the arrangement of the punch through-bores is not limited as such; for example, punch through-bores could be arranged on an angle if desired. Additionally, while punch bores through-bores 58 are shown as comprising cylindrically shaped bores, other geometric configurations are contemplated. Nevertheless, punch through-bores 58 are generally arranged for allowing the oscillation of punch assemblies 35 and 41 between actuated and non-actuated positions. It should be appreciated that various punch assemblies may be used with the present invention and are readily changed by inserting and securing a desired punch assembly into the punch cap counter-bores of the punch support plates.

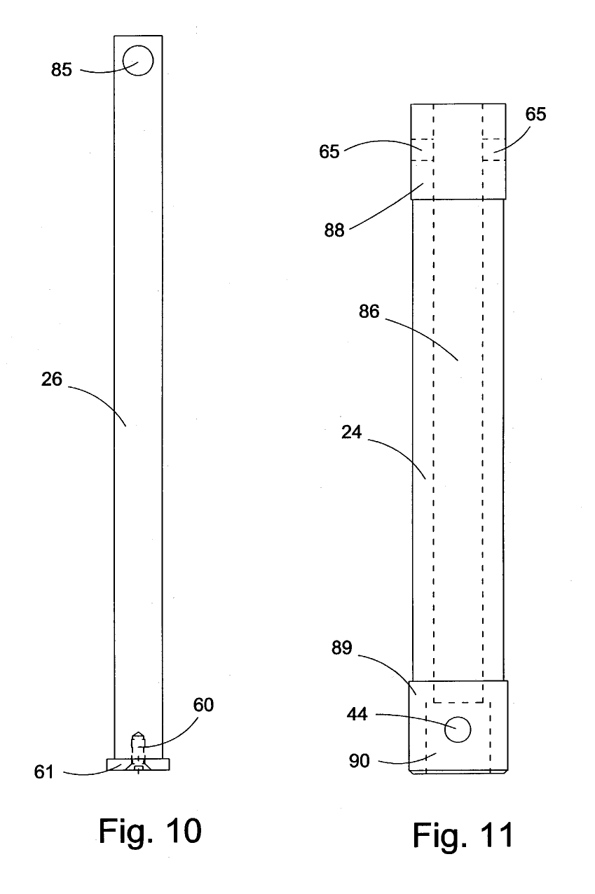

The mandrel of the present invention is generally configured for close fit with the inner wall of a workpiece to be punched so as to prevent damage to the tubular stock during punching operations. As shown in FIGS. 10 and 11, mandrel 24 of the present invention is shown as being cylindrically shaped for purposes of punching cylindrical workpieces, or tubes. Naturally, mandrel 24 may comprise other shapes such as square, rectangular, triangular, arcuate etc., which shape corresponds to the shape of the workpiece to be punched. Thus, it should be appreciated by those having skill in the art that while the Figures illustrate a cylindrical mandrel and arbor housing and punch housing apertures adapted for accepting a cylindrically shaped mandrel and workpiece, the mandrel of the present invention and the associated apertures may be configured to comprise any geometric shape for purposes of punching holes in stock having a corresponding shape.

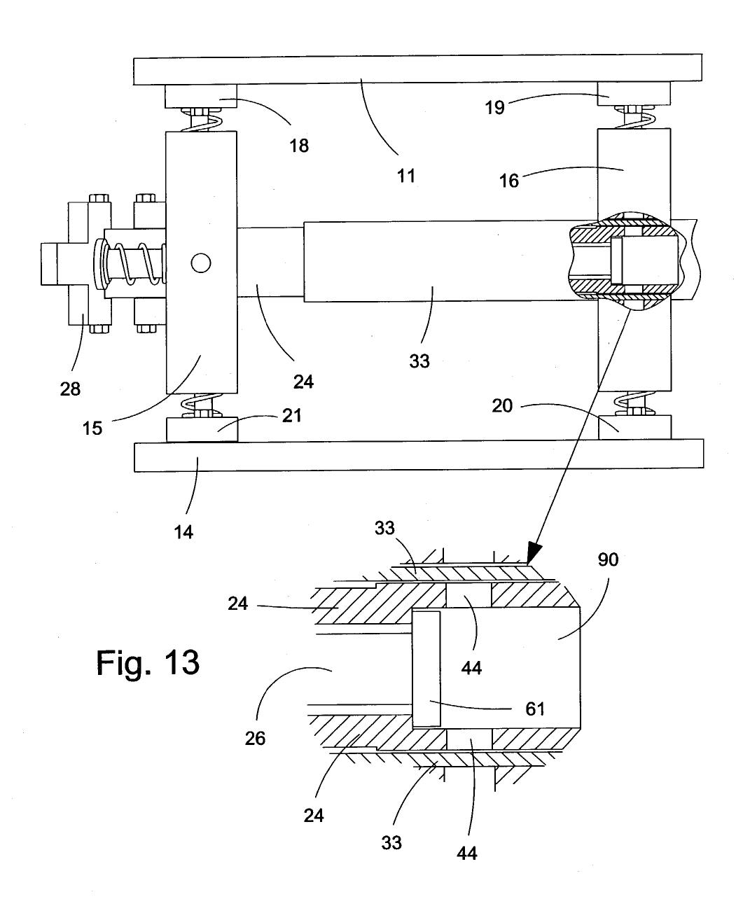

Mandrel 24 generally comprises mandrel mounting end 88, a pair of retaining pin channels 65, mandrel punching end 89 and mandrel through-bore 86. Located proximate mandrel punching end 89 is a pair of mandrel punch through-bores 44. As shown in FIGS. 13-15, mandrel punch through-bores 44 are arranged for communication with mandrel through-bore 86 and are adapted for registration and communication with punch through-bores 58 of punch housing 16 such that punch tips 84 of punch assemblies 41 and 35 may be received during punching operations. Where the punch-through bores of the punch housing are angularly disposed, the mandrel punch bores may be similarly disposed. Mandrel through-bore 86 is operatively arranged to receive and allow translational movement of pushrod 26 therein. Proximate mandrel punching end 89, mandrel 24 additionally comprises pushrod washer counter-bore 90 for accepting pushrod washer 61. Pushrod washer 61 generally serves as the means for removing punched material from the workplace as discussed infra.

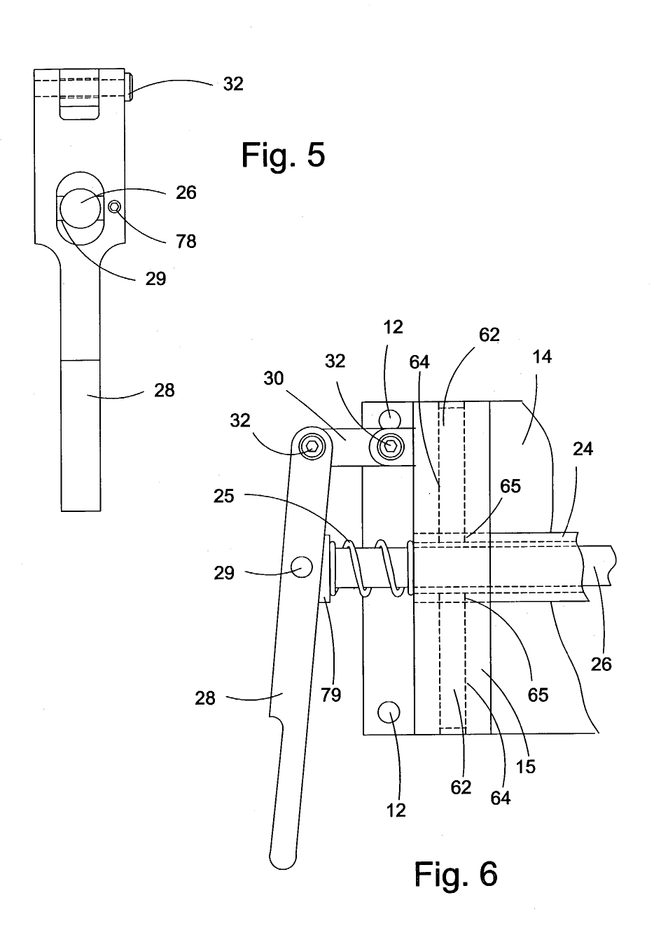

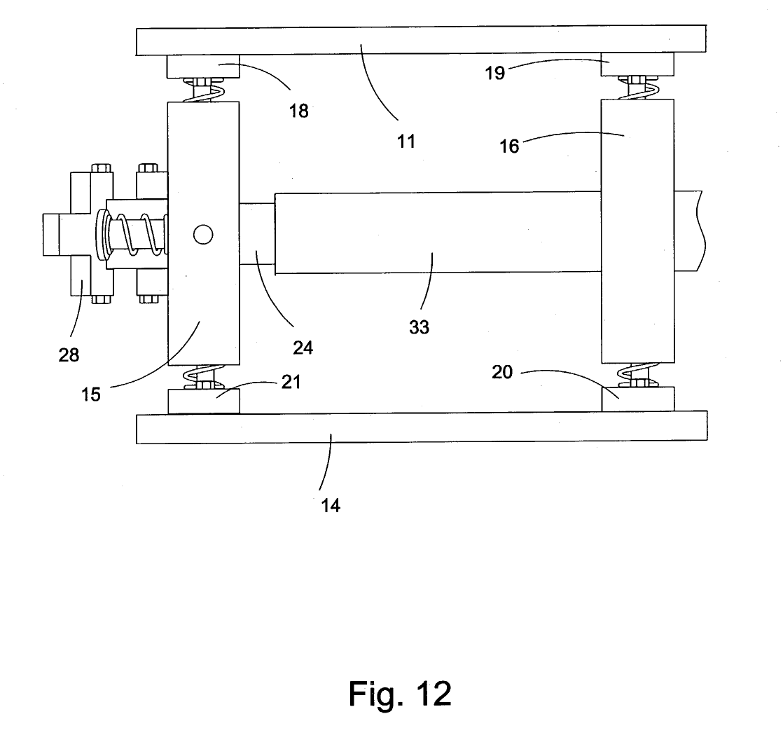

With reference now to FIGS. 1, 4-6, 10-12, 13 and 15, the pushrod assembly and actuating means are provided for manual and/or automatic actuation to efficiently, effectively and safely remove punched material from the work area. As shown more clearly in FIGS. 10 and 11, pushrod 26 is generally elongate and operatively arranged for close fit and slideable movement within mandrel through-bore 86. Pushrod 26 comprises pushrod pinhole 85, which pivotally secures the pushrod to the pushrod operating handle (shown in FIGS. 5-6). Pushrod 26 further comprises pushrod washer 61 which secures to the pushrod by means of mounting screw 60; pushrod washer 61 generally comprises a size and shape which corresponds to the to the size and shape of the inner walls of mandrel counter-bore 90 such that it may effectively remove material from the work area. Pushrod washer 61 may comprise many shapes, however, and may be configured in the manner of a bristled brush, or similar means, for effectively removing material from the work area.

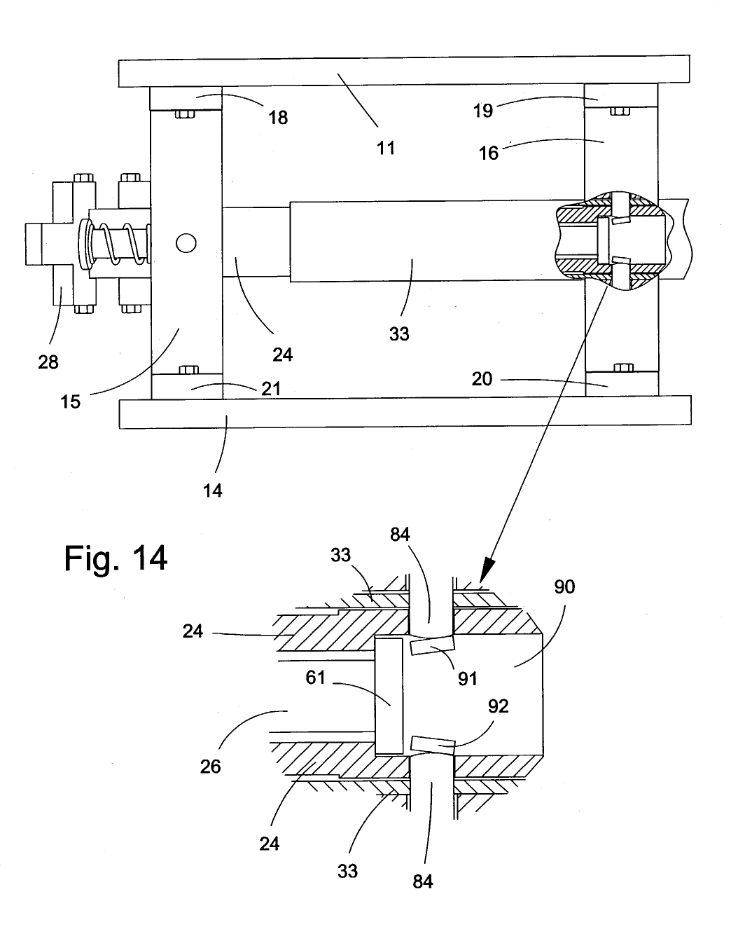

As shown in FIGS. 5 and 6, pushrod handle 28 is pivotally secured to pushrod 26 and pushrod handle connecting block 30, which is secured to pushrod mounting bracket 31 of arbor housing 15. The pushrod handle is pivotally secured to the pushrod via pin 29 and to the pushrod connecting block via bolt 32. Pushrod connecting block 30 is pivotally secured to the pushrod mounting bracket by means of bolt 32. Pushrod handle 28 additionally comprises a through-bore, which is provided for securing pin 29 to the pushrod handle via pin screw 78. As shown more clearly in FIGS. 1 and 6, pushrod compression spring 25 is operatively arranged about the pushrod and between the end of mandrel 24 and pushrod washer 79 to provide a biasing force upon pushrod handle 28 such that it maintains a non-actuated position as shown in FIGS. 13 and 14.

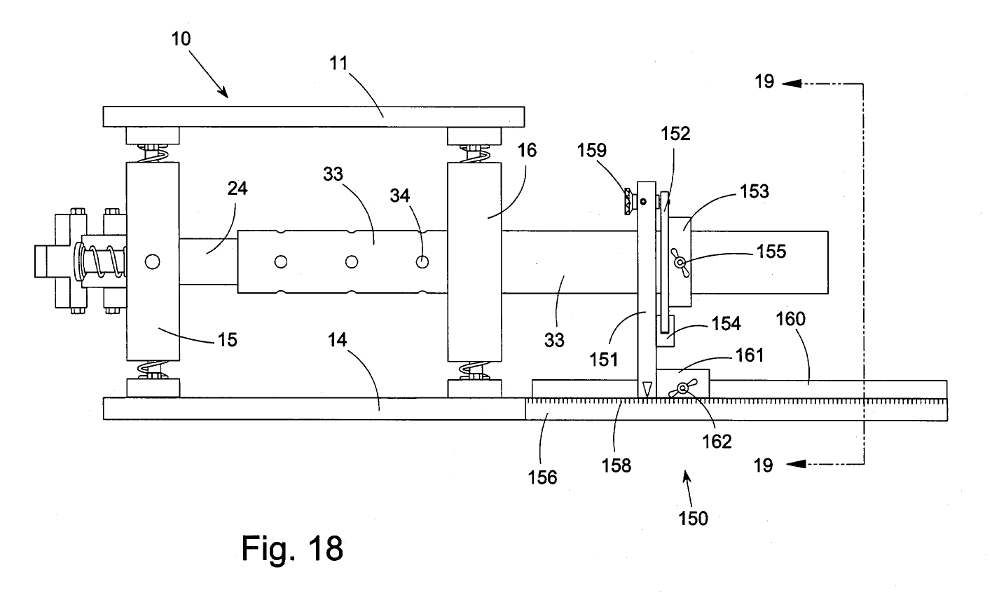

Referring now to FIGS. 18-20, the mandreled punching device of the present invention may also be configured to comprise indexing means 150 for rotationally and laterally indexing a workpiece to be punched such that precisely located holes may be punched into a single workpiece or into a plurality of workpieces. As shown in FIG. 18, indexing assembly 150 broadly comprises indexing wheel mounting plate 151 for rotationally indexing workpiece 33 to be punched and lateral indexing mounting plate 156 for laterally indexing the workpiece to be punched.

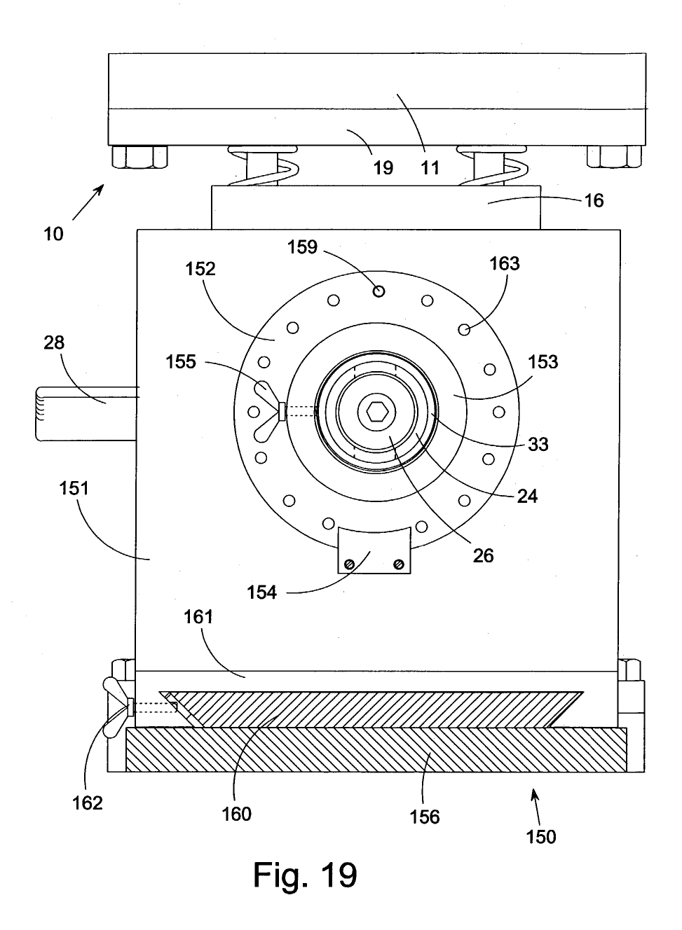

As shown in FIG. 19, indexing wheel mounting plate 151 comprises an aperture for passing workpiece 33 therethrough and further comprises indexing wheel retaining block 154, which rotationally secures indexing wheel 152. Indexing wheel 152 also comprises an aperture for passing a workpiece to be punched and further comprises a plurality of indexing wheel position bores 163 radially disposed about the indexing wheel and configured for accepting indexing wheel position pin 159. Indexing wheel 152 also comprises indexing wheel mounting ring 153 and indexing wheel set screw 155, which secures a workpiece to the mounting ring. Hence, workpiece 33 may be secured to the indexing wheel, rotated, locked in place by means of indexing wheel position pin 159 and precisely punched.

A workpiece may also be laterally indexed. As shown in FIG. 19, indexing wheel mounting plate 151 and adjustment block 161 secure to one another and comprise female dovetails for accepting male dovetail 160 of lateral indexing mounting plate 156. Thus, as shown in FIG. 18, indexing wheel mounting plate 151 and adjustment block 161 are arranged for lateral movement in relation to, and upon, lateral indexing mounting plate 156. Adjustment block 161 further comprises lateral position set screw 162 for securing the adjustment block and the indexing wheel mounting plate in a desired lateral position. Lateral positioning may be set by means of position rule 158.

### Operation of Apparatus

It should be appreciated that the following steps in no way describe the sole methods for punching tubular stock using the present invention; indeed, other methods, steps, or order of steps are contemplated and encompassed by the instant disclosure. Nevertheless, operation of the mandreled tube punch of the present invention and/or punching of tubular stock generally occurs in the following manner: workpiece 33, tubular stock, to be punched is typically inserted and fed through the apertures of indexing wheel 152, indexing wheel mounting plate 151, and punch housing 16. The end of the workpiece is then secured about mandrel 24. The workpiece is then secured to the indexing wheel mounting ring by means of the indexing wheel set screw. Once secured to the indexing wheel, the indexing wheel pin is disengaged such that the indexing wheel and workpiece 33 may freely rotate. Once a desired rotational position is achieved, the indexing wheel pin is re-engaged to rotationally secure the workpiece. Thereafter, the lateral position of the workpiece may be adjusted. To laterally adjust the position of the workpiece, lateral position set screw 162 is disengaged, or loosened, and the indexing wheel mounting plate 151 and adjustment block 161 are positioned, or slid, with respect to lateral indexing mounting plate 156 to a desired lateral position. Upon achieving a desired lateral position, the lateral position set screw may be re-engaged, or tightened, to secure the adjustment block and the indexing wheel mounting plate in place.

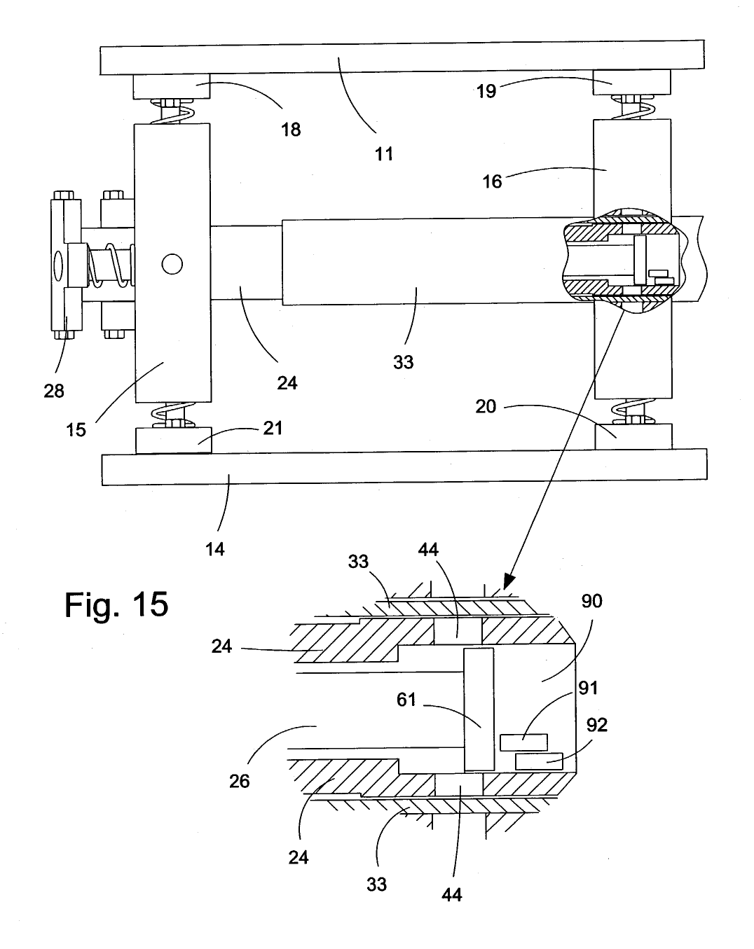

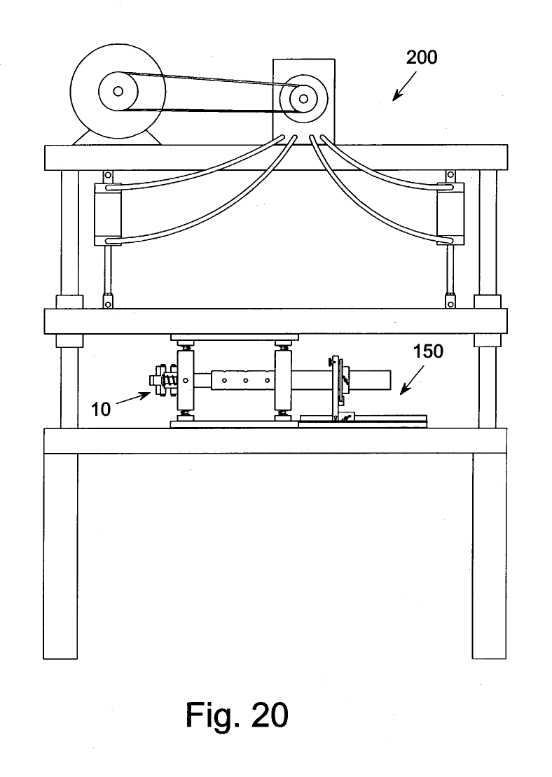

Once desired rotational and lateral positioning of the workpiece is achieved, it is now ready for punching. As shown in FIG. 20, the mandreled punching device of the present invention may be configured for use with punching press 200 of a type generally known in the art, which applies a sufficient compression force, or punching force, to upper punch plate 11 and lower punch plate 14 to cause punch assemblies 41 and 35 to pierce the walls of tubular stock 33. As shown in FIGS. 13-15, upon application of a punching force, the upper and lower punch plates are caused to compress such that attached upper and lower punch assemblies 41 and 35, respectively, are caused to pass through punch through-bores 58. Upper and lower punch assemblies 41 and 35 continue to traverse through punch through-bores 58 until the lower limit of travel of the punch assemblies is reached. At or near the lower limit of travel punch tips 84 of the punch assemblies pierce the walls of the workpiece and enter upper and lower mandrel punch through-bores 44 and deposit punched material 91 and 92 therein. Thereafter, the punching force applied to the upper and lower punch plates is de-asserted, which causes the punch plates and punch assemblies to return to the start position (shown in FIGS. 13 and 15). As shown in FIG. 15, upon completion of the punching operation, punched material 91, 92 deposited in the pushrod washer counter-bore 90 of the mandrel is removed by the assertion of a force upon pushrod handle 28, which causes the lateral movement of pushrod 26 within mandrel 24. As is apparent, the movement of pushrod 26 within mandrel 24 causes pushrod washer 61 to act upon punched material 91, 92 to remove the deposited material from the work area. De-assertion of the force applied to the pushrod handle allows biasing force of spring 25 to act on the pushrod handle, which causes the handle and the pushrod to return to the start position (shown in FIG. 14). Thereafter, the position of the workpiece to be punched may be rotationally or laterally adjusted, or the workpiece removed and a new workpiece inserted for further punching operations.

It should be readily appreciated that the cantilevered mandrel of the present invention, in combination with the punch-housing aperture, provides substantial support to the tubular stock and to the walls of the tubular stock. As a result, damage to the tubular stock is minimized and/or prevented using the mandreled punching device of the present invention.

Thus, it is seen that the objects of the present invention are efficiently obtained, although it should be readily apparent to those having ordinary skill in the art that changes and modifications can be made to the invention without departing from the spirit and scope of the invention as claimed. It should especially be appreciated that the subject invention may be configured for punching tubular stock comprising shapes other than cylindrical and may be configured for punching in directions other than perpendicular. Hence, variations of the mandreled punching device may be made, used and sold, and yet be within the spirit and scope of the claims.

What is claimed is:

1. A punching device for a workpiece comprising:
a cantilevered mandrel, an arbor housing securing said cantilevered mandrel; said mandrel having a bore longitudinally disposed therethrough; said mandrel adapted to secure said workpiece;
evacuation means disposed within said longitudinally disposed mandrel bore adapted for translational movement therein;
at least one punching means for punching said workpiece; and,
a punch housing comprising an aperture for accepting a workpiece positioned on said mandrel.

2. The punching device of claim 1 wherein said arbor housing comprises means for engaging and releasably securing said mandrel.

3. The punching device of claim 1 wherein said mandrel further comprises a mandrel punch bore operatively arranged for communication with said longitudinally disposed mandrel bore.

4. The punching device of claim 3 wherein said punch housing comprises at least one punch bore allowing the translational movement of said at least one punching means therein.

5. The punching device of claim 4 wherein said punch bore, said aperture and said mandrel punch bore are operatively arranged for communication.

6. The punching device of claim 1 wherein said evacuation means comprises a pushrod.

7. The punching device of claim 6 wherein said pushrod comprises a pushrod washer having a cross sectional shape corresponding to the cross sectional shape of said longitudinally disposed mandrel bore.

8. The punching device of claim 6 wherein the translational movement of said pushrod is manually affected.

9. The punching device of claim 1 wherein the cross-section of said mandrel is arcuate.

10. The punching device of claim 1 wherein the cross-section of said mandrel is polygonal.

11. The punching device of claim 1 comprising punch biasing means adapted to allow said punching means to maintain a non-actuated configuration.

12. The punching device of claim 11 wherein said punch biasing means comprises compression springs.

13. The punching device of claim 1 comprising pushrod biasing means for biasing said pushrod to maintain a non-actuated configuration.

14. The punching device of claim 13 wherein said pushrod biasing means comprises compression springs.

15. The punching device of claim 1 comprising means for indexing said tubular stock.

16. The punching device of claim 1 further comprising a second punching means and a second punch bore, said second punch bore allowing the translational movement of said second punching means therein.

17. The punching device of claim 16 wherein said punch bore and said second punch bore are oppositely disposed.

18. A punching device for a workpiece comprising:
a cantilevered mandrel, an arbor housing securing said cantilevered mandrel; said mandrel having a bore longitudinally disposed therethrough; said mandrel adapted to secure said workpiece;
spring biased evacuation means comprising a pushrod disposed within said longitudinally disposed mandrel bore and adapted for translational movement within said mandrel bore;
spring biased punching means for punching said workpiece; and,
a punch housing comprising an aperture for accepting a workpiece positioned on said mandrel.

19. A punching device for a workpiece comprising:
a cantilevered mandrel, an arbor housing securing said cantilevered mandrel; said mandrel having a first bore longitudinally disposed therethrough; a second bore adapted for intersection with said punch bore; said mandrel adapted to secure said workpiece;
spring biased evacuation means comprising a pushrod disposed within said first bore and adapted for translational movement therein;
spring biased punching means for punching said workpiece; and,
a punch housing comprising an aperture and a third bore; said aperture adapted for accepting a workpiece positioned on said mandrel; said third bore adapted for communication with said aperture and said second bore of said mandrel; said punching means adapted for translational movement between said second and third bores.
